(19) United States
(12) Patent Application Publication
(10) Pub. No.: US 2004/0211303 A1
(43) Pub. Date: Oct. 28, 2004

(54) Steel rule cutting die and method of mounting cutting knife cavities for improved scrap material removal

(76) Inventors: Marty Paul Horning, Smith Creek, MI (US); David Arthur Hunwick, St. Clair, MI (US); Michael Rupert Geffros, Fort Gratiot, MI (US)

Correspondence Address: ANDREW ALEXANDER & ASSOCIATES, 3124 KIPP AVENUE, P.O. BOX 2038, LOWER BURRELL, PA, 15068, US

(21) Appl. No.: 10/704,387

(22) Filed: Nov. 7, 2003

Related U.S. Application Data
(60) Provisional application No. 60/424,322, filed on Nov. 7, 2002.
(60) Provisional application No. 60/428,275, filed on Nov. 22, 2002.

(51) Int. Cl. B26D 1/00; B26D 3/00; B21K 5/20

(52) U.S. Cl. 83/13; 83/698.11; 83/698.71; 76/107.1

(57) ABSTRACT

A steel rule cutting die is provided and includes a baseboard, and cutting knifes including an integral cross member having holes having a first diameter. The cutting knifes may be bent to form an enclosed cavity. Fasteners including a head and a shaft having second and third diameters, respectively, are provided, and are disposable within the hole in the cross member for connecting the cutting knife to the baseboard. Washers including a fourth outer diameter and a hole having a fifth diameter, are provided. The first diameter may be greater than the third diameter, the second diameter may be greater than the fifth diameter, and the fourth diameter may be greater than the first diameter, such that, when the washer is disposed under the fastener head, the washer prevents the head from entering the hole in the cross member, and facilitates translation of cavities parallel to the baseboard.

### RELATED APPLICATIONS

This application claims benefit of priority of Provisional Application Ser. No. 60/424,322, filed Nov. 7, 2002, and 60/428,275, filed Nov. 22, 2002.

### BACKGROUND OF INVENTION

a. Field of Invention

The invention relates generally to cutting dies, and, more particularly to an improved steel rule cutting die including cavities adjustable in a plurality of directions for facilitating removal of material, and further having a reduced gap therebetween for reduction in the amount of scrap material.

b. Description of Related Art

Steel rule cutting dies generally include a piece of band steel, having a sharpened edge, bent into a pre-defined shape. The bent steel may be mounted onto a baseboard, for example, so as to form a plurality of cavities. The cavities may be rigidly affixed to the baseboard by screws, through slots cut in the baseboard, and other such means, and disposed in a pre-defined spatial (or nested) arrangement. The spatial arrangement may be governed by a plurality of factors, one of which is aimed towards the minimization of scrap material.

Steel rule cutting dies may be used in countless applications, including cutting cardboard boxes, garments, composites, plastics, and material used in automotive interior trim, i.e. head liners, head rests, seats, door panels, trunk liners and the like. The cutting process generally involves a steel rule cutting die being pressed onto stock material to separate the material into useful pieces and waste product (i.e. scrap material). The useful pieces within the cavities may be removed for subsequent processing. The waste product disposed in between adjacent cavities may be discarded. Accordingly, it is apparent that for products made by the millions, waste product can significantly add to the overall cost of the end product and/or the manufacturing process costs. Therefore, minimization, or even elimination of unnecessary waste product becomes a significant factor in the design of steel rule cutting dies.

In the case of steel rule cutting dies, as disclosed in U.S. Pat. No. 6,233,809 to Geffros et al., the disclosure of which is incorporated herein by reference, there has been designed, manufactured and utilized herewith a flexible steel rule cutting die and a method of mounting cutting knife cavities with mounting braces. Various other conventional steel rule cutting dies and associated inventions, are known and disclosed, for example, in U.S. Pat. No. 5,676,032 to Johnson (hereinafter “'032 patent”), U.S. Pat. No. 6,408,729 to Johnson (hereinafter “'729 patent”), and U.S. Pat. No. 5,983,766 to Johnson (hereinafter “'766 patent).

Specifically, the '032 patent discloses a steel rule cutting die having closely nested cavities. The close nesting arrangement of the cavities is enabled by the design of the cutting knife, which includes an off-center cutting edge. By placement of the cutting edge adjacent the outer periphery of a cavity, the amount of waste material between adjacent cavities may be reduced. The amount of reduction of waste material for the '032 patent is however limited by distance between adjacent cavities, which can only be reduced up to a certain extent. The primary limiting factors which govern the minimum distance between adjacent cavities include, for example, blade thickness, the necessity for a user to remove the waste material, and the cutting characteristics of adjacent cavities which require a sufficient distance therebetween to prevent the material from bending or flexing excessively.

The '766 and '729 patents attempt to overcome the above-identified drawbacks and deficiencies by allowing displacement of the cavities and facilitating removal of scrap material, respectively.

Specifically, the '726 patent is directed to movable cavities which enable a user to adjust, remove or replace the cavities (i.e. cutting units). The cavities, which are loosely mounted to a primary substrate, include a secondary substrate. The secondary substrates include tear-drop shaped holes in which studs mounted on the primary substrate may be inserted, and thereafter loosened or tightened to enable adjustment, removal or replacement of the cavities, and removal of waste material. It becomes readily apparent that in a high-volume manufacturing process, such tightening and re-tightening of studs, and adjustment and re-adjustment of cavities between each cutting operation can be extremely time-consuming, and therefore impractical.

The '729 patent is directed to a cutting knife having a specific blade design. The '729 patent also fails to fully overcome the drawbacks of the prior-art steel rule cutting dies described above.

Accordingly, there is a present need for a steel rule cutting die, which enables a user to efficiently adjust, remove or replace cavities as needed, and further enables a user to position cavities in a tightly nested configuration so as to minimize waste material.

### SUMMARY OF INVENTION

The invention solves the problems and overcomes the deficiencies of the prior art by providing a novel steel rule cutting die having an improved method of affixing cavities, in order to facilitate removal of material and reduce the amount of scrap material, and to further facilitate adjustment, removal or replacement of cavities.

Specifically, the invention provides a steel rule cutting die including a baseboard, and at least one cutting knife including an integral cross member. The cross member may include at least one hole having a first diameter. The cutting knife may be bent to form an enclosed cavity. At least one fastener including a head and a shaft having second and third diameters, respectively, may be provided. The fastener may be disposable within the hole for connecting the cutting knife to the baseboard. At least one washer including a fourth outer diameter and further including a hole having a fifth diameter, may be provided. The first diameter may be greater than the third diameter, the second diameter may be greater than the fifth diameter, and the fourth diameter may be greater than the first diameter. When the washer is disposed under the head of the fastener, the washer prevents the head from entering the hole in the cross member.

For the steel rule cutting die described above, at least one L-shaped spacer including two fork-shaped protrusions, may also be provided. Each of the protrusions may be disposable adjacent diametrically opposed ends of the shaft, and between the head of the fastener and the washer. Alternatively, at least one spacer including at least one protrusion disposable adjacent a diametric edge of the shaft along a length of the shaft, and between the head of the fastener and the washer, may be provided.

The invention further provides a method for assembling a cutting knife assembly. The method includes providing at least one cutting knife including an integral cross member. The cross member may include at least one hole having a first diameter. The cutting knife may be bent to form an enclosed cavity. The method may further include mounting at least one fastener including a head and a shaft having second and third diameters, respectively, within the hole for connecting the cutting knife to the baseboard, and tightening the fastener to permit translation of the cutting knife generally parallel to the baseboard. The method may also include providing at least one washer, including a fourth outer diameter and further including a hole having a fifth diameter, between the head of the fastener and the hole in the cross member. The first diameter may be greater than the third diameter, the second diameter may be greater than the fifth diameter, and the fourth diameter may be greater than the first diameter, such that the washer prevents the head of the fastener from entering the hole in the cross member.

The invention further provides a method for utilizing a steel rule cutting die. The method includes pressing stock material onto the steel rule cutting die to cut the stock material into cut material sections and waste material sections, the cut material sections being disposed within cavities and the waste material sections being disposed between adjacent cavities, and removing the cut material sections within each cavity. The method further includes removing some of the waste material sections between adjacent cavities to thereby relieve pressure between adjacent cavities so as to facilitate removal of any remaining waste material sections by permitting cavities having waste material sections removed therebetween to translate generally parallel relative to the baseboard, and removing any remaining waste material sections.

For the method described above, the method further includes providing at least one L-shaped spacer including two fork-shaped protrusions, and disposing each of the protrusions adjacent diametrically opposed ends of the shaft, and between the head of the fastener and the washer. The spacer may be nudged or removed to facilitate generally parallel translation of cavities.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a perspective view of a first embodiment of a steel rule cutting die according to the present invention;

FIG. 2 is top view of the steel rule cutting die of FIG. 1, illustrating a single cavity;

FIG. 3 is an exemplary perspective view of a second embodiment of a steel rule cutting die, including multiple steel rule cutting dies and L-shaped spacers;

FIG. 4 is a top view of the steel rule cutting dies of FIG. 3, illustrating nested cavities including L-shaped spacers;

FIG. 5 is yet another top view of the steel rule cutting dies of FIG. 3, illustrating nested cavities including L-shaped spacers; and

FIG. 6 is a perspective view of a third embodiment of a steel rule cutting die, illustrating nested cavities including L-shaped spacers.

### DETAILED DESCRIPTION OF THE PREFERRED EMBODIMENT

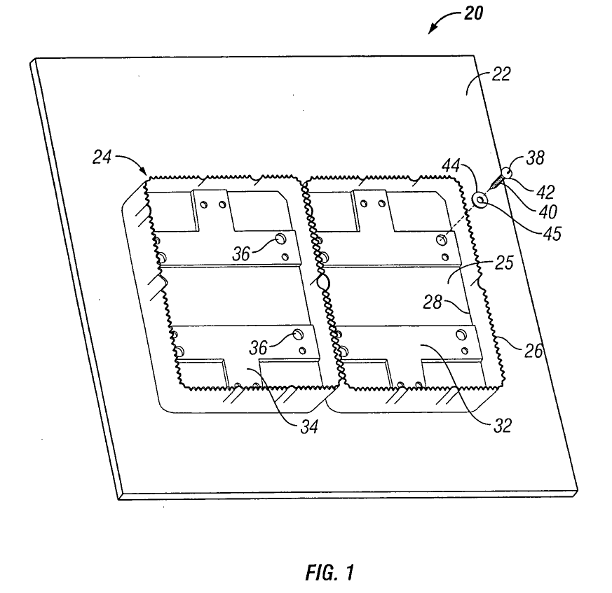

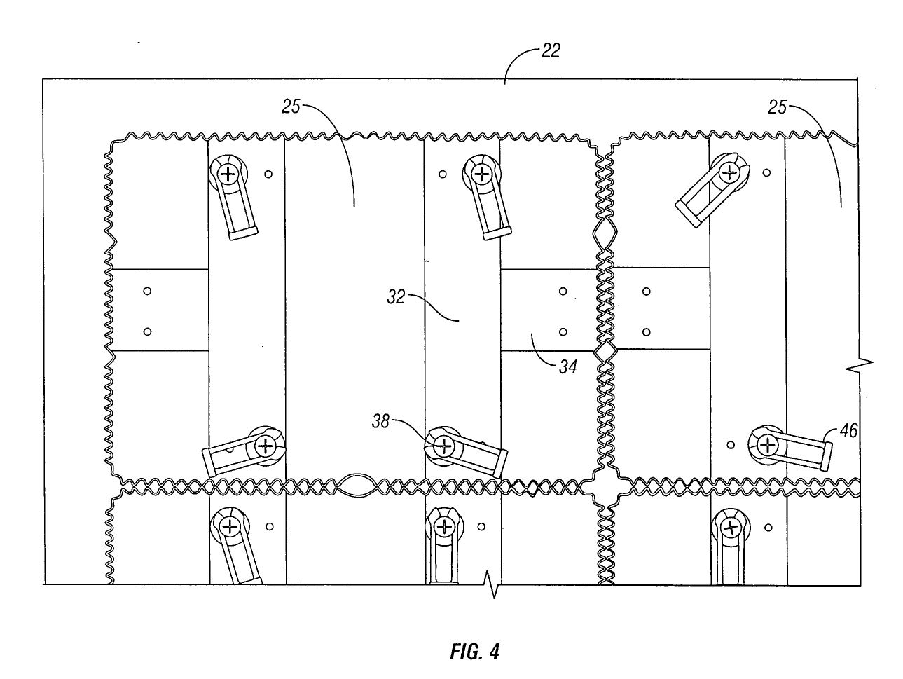

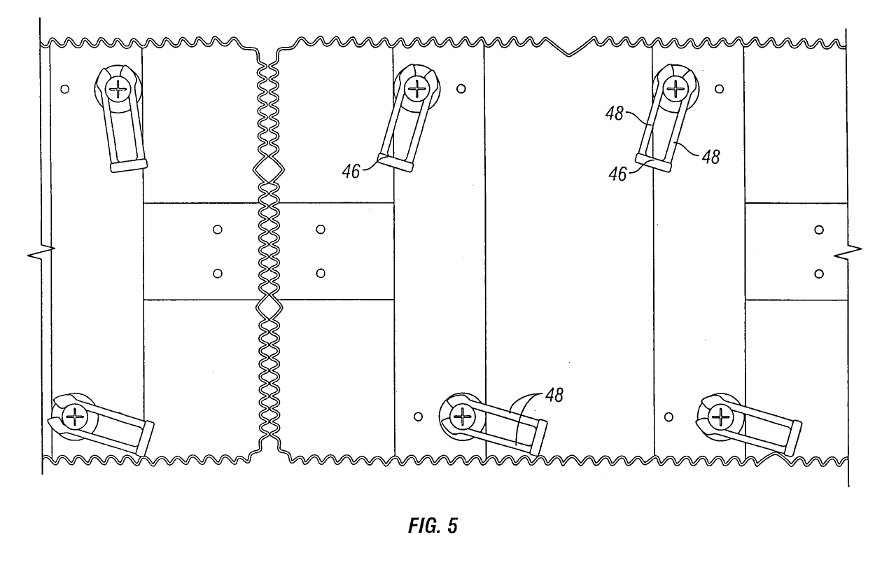

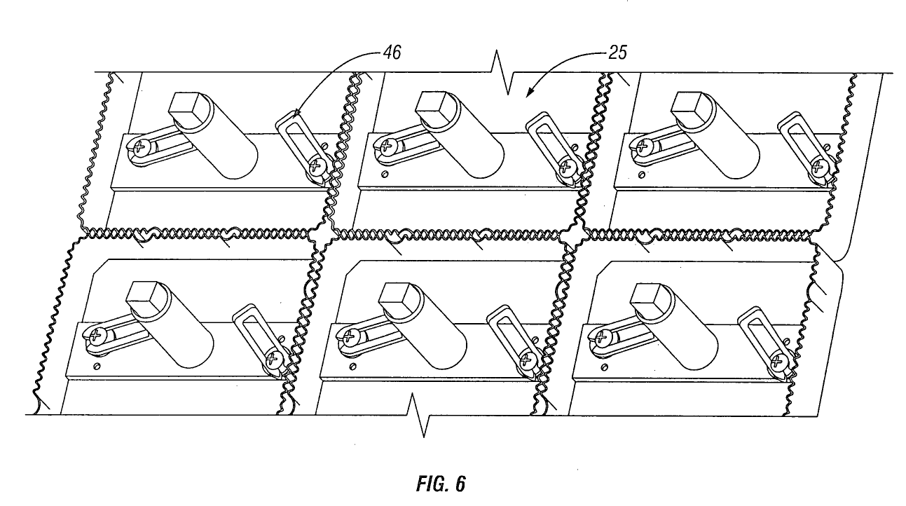

Referring now to the drawings wherein like reference numerals designate corresponding parts throughout the several views, FIGS. 1-6 illustrate a steel rule cutting die according to the present invention, generally designated 20.

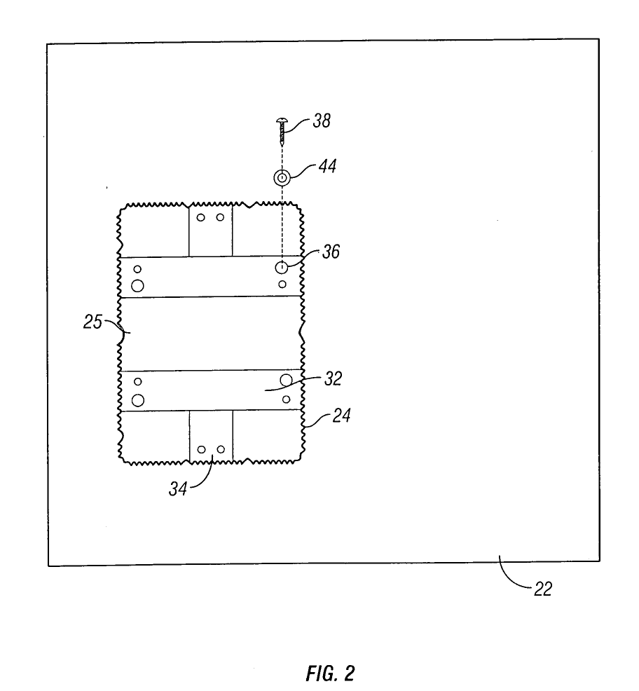

As shown in FIGS. 1-6, and specifically FIGS. 1-2, steel rule cutting die 20 may include a baseboard 22 on which a plurality of cutting knives 24 may be removably mounted. Cutting knives 24 may be made of a single piece of metal bent into a predetermined shape, or of multiple pieces of metal, as would be apparent to a skilled artisan. The bent shape of cutting knives 24, including the first and second cross members 32 and 34 (described below), respectively, will be hereinafter designated, cavity 25. Cutting knives 24 may include a top edge 26 having a cutting edge formed thereon, and a bottom edge 28 having a generally flat configuration. At least one first cross member 32 may be affixed adjacent the bottom edge 28 by welding, for example, for facilitating installation, removal and adjustment of cavity 25 relative to baseboard 22. It is foreseeable that other means may be used to affix cross member 32 adjacent the bottom edge 28, as would be apparent to a skilled artisan. A second cross member 34 may be affixed to first cross member 32 by welding, for example, to provide additional rigidity to the structure of cavity 25. Alternatively, second cross member 34 may be formed with first cross member 32. Each cross member 32 may include a plurality of holes 36 formed therein. Fasteners 38 may be inserted in holes 36 for affixation of cavities 25 on baseboard 22.

In order to facilitate scrap material removal, cavities 25 may be designed to translate generally parallel to the plane of baseboard 22. Specifically, holes 36 may be oversized, or in other words, include a diameter greater than the diameter of shaft 40 of fasteners 38. A washer 44 may be provided under head 42 of fastener 38 to prevent head 42 from sliding through hole 36. Specifically, washer 44 may include a hole 45 having a diameter smaller than the diameter of shaft 40. Accordingly, by providing oversized holes 36, cavities 25 may have a free range of movement generally parallel to baseboard 22.

The design of steel rule cutting die 20, as described above, enables placement of cavities 25 virtually right next to each other. Specifically, cavities 25 may be placed in a nested configuration as close as 1/16, or even in touching engagement with each other.

Baseboard 22 may be made of a hard-wood such as birch, beech or maple, for example, or may be made of a metal, plastic or composite. Cutting knives 24 may be made of a metal such as steel and the like.

An exemplary production operation of die cutting a layer of stock material and scrap removal will now be described in detail.

In operation, a plurality of layers of stock material (not shown) may be pressed onto steel rule cutting die 20 in the conventional manner. Thereafter, the cut material may be removed from within cavities 25. Any waste material in between adjacent cavities 25 may thus be removed without having to specifically relieve the pressure between individual cavities 25 by loosening fasteners 38. For example, once a certain amount of scrap material has been removed from cavities 25 adjacent one end of steel rule cutting die 20, those cavities may freely translate generally parallel to the plane of baseboard 22. This translation of cavities 25, which have the waste material between them removed, would remove the pressure between cavities 25 having the waste material removed therebetween and cavities 25 still having waste material therebetween. In this manner, waste material present between cavities 25 could be removed in its entirety, without having to loosen fasteners 38 and without the waste material becoming jammed between adjacent cavities 25.

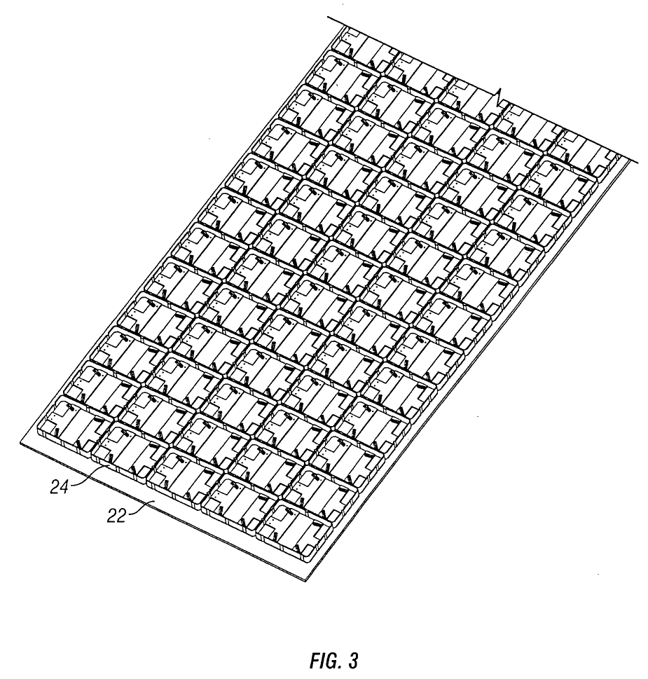

Referring to FIGS. 1-6, and specifically FIGS. 3-6, in alternative second and third embodiments, steel rule cutting die 20 may include elongated L-shaped spacers 46 having two forks 48. Each fork 48 of spacer 46 may be positioned adjacent shaft 40 of fastener 38, and in between head 42 of fastener 38 and washer 44. In the event a cavity 25 becomes locked or wedged, spacer 46 may be removed to further loosen the locked cavity 25 and to facilitate removal of waste material. Alternatively, in the event a cavity 25 becomes locked or wedged, spacer 46 may be nudged to facilitate movement of the locked cavity 25.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

### Glossary Of Terms

20. steel rule cutting die

22. baseboard

24. cutting knives

25. cavity

26. top edge

28. bottom edge

32. first cross member

34. second cross member

36. holes

38. Fasteners

40. shaft

42. head

44. washer

45. hole

46. spacer

48. fork

What is claimed is:

1. A steel rule cutting die comprising:
a baseboard;
at least one cutting knife including an integral cross member, said cross member including at least one hole having a first diameter, said cutting knife being bent to form an enclosed cavity;
at least one fastener including a head and a shaft having second and third diameters, respectively, said fastener being disposable within said hole for connecting said cutting knife to said baseboard; and
at least one washer including a fourth outer diameter and further including a hole having a fifth diameter,
wherein said first diameter being greater than said third diameter, said second diameter being greater than said fifth diameter, said fourth diameter being greater than said first diameter, and when said washer is disposed under said head of said fastener, said washer prevents said head from entering said hole in said cross member.

2. A steel rule cutting die according to claim 1, further comprising:
at least one L-shaped spacer including two fork-shaped protrusions, each of said protrusions being disposable adjacent diametrically opposed ends of said shaft, and between said head of said fastener and said washer.

3. A steel rule cutting die according to claim 1, further comprising:
at least one spacer including at least one protrusion disposable adjacent a diametric edge of said shaft along a length of said shaft, and between said head of said fastener and said washer.

4. A method for assembling a cutting knife assembly, said assembly having a baseboard, said method comprising:
providing at least one cutting knife including an integral cross member, said cross member including at least one hole having a first diameter, said cutting knife being bent to form an enclosed cavity;
mounting at least one fastener including a head and a shaft having second and third diameters, respectively, within said hole for connecting said cutting knife to said baseboard;
tightening said fastener to permit translation of said cutting knife generally parallel to said baseboard; and
providing at least one washer, including a fourth outer diameter and further including a hole having a fifth diameter, between said head of said fastener and said hole in said cross member,
wherein said first diameter being greater than said third diameter, said second diameter being greater than said fifth diameter, said fourth diameter being greater than said first diameter, such that said washer prevents said head of said fastener from entering said hole in said cross member.

5. A method according to claim 4, further comprising:
providing at least one L-shaped spacer including two fork-shaped protrusions; and
disposing each of said protrusions adjacent diametrically opposed ends of said shaft, and between said head of said fastener and said washer.

6. A method according to claim 4, further comprising:
providing at least one spacer including at least one protrusion; and
disposing said protrusion adjacent a diametric edge of said shaft along a length of said shaft, and between said head of said fastener and said washer.

7. A method for utilizing a steel rule cutting die according to claim 1, said method comprising:
pressing stock material onto said steel rule cutting die to cut the stock material into cut material sections and waste material sections, the cut material sections being disposed within cavities and the waste material sections being disposed between adjacent cavities;
removing the cut material sections within each cavity;
removing some of the waste material sections between adjacent cavities to thereby relieve pressure between adjacent cavities so as to facilitate removal of any remaining waste material sections by permitting cavities having waste material sections removed therebetween to translate generally parallel relative to said baseboard; and
removing any remaining waste material sections.

8. A method according to claim 7, further comprising:
providing at least one L-shaped spacer including two fork-shaped protrusions;
disposing each of said protrusions adjacent diametrically opposed ends of said shaft, and between said head of said fastener and said washer; and
one of:
nudging said spacer to facilitate said generally parallel translation of cavities, and
removing said spacer to facilitate said generally parallel translation of cavities.

9. A method according to claim 7, further comprising:
providing at least one spacer including at least one protrusion;
disposing said protrusion adjacent a diametric edge of said shaft along a length of said shaft, and between said head of said fastener and said washer; and
one of:
nudging said spacer to facilitate said generally parallel translation of cavities, and
removing said spacer to facilitate said generally parallel translation of cavities.
